(19) United States
(12) Patent Application Publication
(10) Pub. No.: US 2007/0202222 A1
(43) Pub. Date: Aug. 30, 2007

(54) Tubular Food Casing Having Transferable Inner Layer

(76) Inventors: Martina Koenig, Wiesbaden (DE); Volker Effern, Bad Schwalbach (DE); Sabrina Hofmann, Holzhausen (DE); Roland Kleinschmidt, Taunusstein (DE); Ralf Borst, Floersheim (DE)

Correspondence Address: ProPat;Cathy R Moore, 425-C South Sharon Amity Road, Charlotte, NC, 28211, US

(21) Appl. No.: 11/547,208

(22) PCT Filed: Apr. 2, 2005
(86) PCT No.: PCT/EP05/03483

§ 371 Date: Sep. 29, 2006

(30) Foreign Application Priority Data
Apr. 8, 2004 (DE) 102004017351.6

(51) Int. Cl. A22C 13/00

(52) U.S. Cl. 426/135; 426/250

(57) ABSTRACT

The invention relates to a tubular food casing based on textile material or regenerated cellulose which has on the inside an impregnation or coating which comprises at least one colorant which is transferable to a foodstuff situated in the casing and/or a coloring foodstuff (=coloring agent), but no binder. Particularly suitable coloring agents are cereal varieties and preparations thereof, such as barley, barley malt and barley malt extract, caramel, spices, cocoa, coffee, fruits or vegetable varieties. Solid coloring agents are expediently comminuted to a maximum particle size of 0.5 mm. The casing is provided in particular as artificial sausage casing.

The present invention relates to a tubular food casing which is impregnated on the inside with transferrable colorants and/or flavorings. It also relates to a process for producing the food casing and also the use thereof as artificial sausage casing.

Tubular food casings, especially sausage casings, which contain substances transferrable to the foodstuff, such as food colors, spices, aromas, flavorings or the like, are already known. For instance, EP-A 0 986 957 describes a casing having a layer based on polyolefin, polyester, polyvinylidene chloride, polyvinyl chloride or polystyrene and also a further layer which is provided for the food contact. This inner layer comprises a polysaccharide and/or a protein as binder and, mixed therewith, an aroma substance and/or flavoring, such as grilled chicken aroma, cinnamon, caramel, honey, citron oil or orange oil. WO 98/31731 discloses a very similar food casing in which the inner layer in addition contains a crosslinker, for example a compound having 2 or more carbaldehyde groups.

The casing according to EP-A 0 992 194 likewise comprises a layer made of synthetic polymers acting as water vapor barrier and/or oxygen barrier. Here, this layer, however is joined to an inner layer made of a fibrous nonwoven or similar material which is impregnated with transferrable colorants and/or aroma substances, in particular with liquid smoke.

The sausage casing according to DE-A 195 00 470 has on the inside an adhesive layer solidifying in the liquid state. Before solidification, spice particles, in particular peppercorns or ground pepper, are applied thereto. This proceeds in particular by spinning-on using special devices.

WO 00/40093 discloses a food casing made of a synthetic thermoplastic material into which an additive is incorporated which serves for forming very small (0.002 to 1 μm) pores and/or channels. The casing becomes as a result permeable to smoke or similar substances. In addition, the thermoplastic material can also be mixed with colorants or aroma substances. Since the colorant and/or aroma substance is incorporated into the casing, it is only transmitted to a limited extent to the food situated in the casing.

The object was therefore still to provide a food casing which stores a colorant which is preferably simultaneously also an aroma substance and/or flavoring, and then can rapidly and uniformly in an adequate amount release it to a food situated in the casing.

It has now been found that the object can be achieved by a tubular casing based on textile material or possibly fiber-reinforced cellulose which is impregnated on the inside with a coloring food. A particularly good result has been achieved when the colored food has not been mixed with a binder. This was surprising, since in the documents cited in the prior art, the importance of the binder has always been emphasized.

The present invention accordingly relates to a tubular food casing based on textile material or regenerated cellulose which is impregnated or coated on the inside with at least one foodstuff colorant or coloring food, the impregnation or coating not containing a binder. Preferably, the foodstuff colorant or the coloring food in addition has aroma-enhancing and/or flavor-enhancing or -modifying action.

The foodstuff colorant or the coloring food (in association with the present invention together termed “coloring agent”) is generally applied in the form of an (aqueous) solution, emulsion, or dispersion. Solid coloring agents should be finely ground, the maximum particle size preferably being less than 0.5 mm. The mean particle size is generally less than 0.3 mm, preferably less than 0.2 mm, particularly preferably 5 to 300 μm, especially 10 to 150 μm. The particle size is important to ensure sufficient adhesion to the inside of the food casing. Excessively large particles are, moreover, torn away by the sausage meat emulsion during stuffing.

The impregnation or coating on the inside of the inventive food casing comprises no binder. The inherent color, flavor and/or aroma of the coloring agent are therefore not diminished or adulterated. The properties typical of the respective coloring agent thus become particularly noticeable.

Particularly preferred coloring agents are sugar coloring, food colorants E124 (cochineal red A), E155 (brown HT), E120 (carmine), paprika oleoresin (E160C), concentrates and extracts of elderberry, plums or tomatoes, cereals (in particular barley) and preparations thereof (such as malt or malt extract), spices (for example chilli), caramel, coffee, cocoa, chicory, carob bean meal, fruits (for example pineapple) or paprika and also mixtures thereof. If it is not already water-soluble, the coloring agent is expediently comminuted or ground (for example after previous freeze drying), so that a uniform, relatively thin and readily adhering internal coating may thereby be produced.

The coloring agent is preferably combined with at least one component which improves the wettability of the inside of the casing. This component is preferably an oil, in particular an animal- or vegetable-based oil (olive oil, rapeseed oil etc.), or lecithin. It ensures particularly uniform and interruption-free application of the coloring agent. The fraction of the component in the coating or impregnation liquid is expediently about 3 to 45% by weight, preferably about 5 to 35% by weight.

The amount in which the coloring agent is applied depends absolutely on its type. In most cases it has proved to be expedient to apply the agent in an amount of 3 to 18 g/m², preferably 5 to 15 g/m². The total weight of the impregnation or coating is, after drying, preferably about 3 to 30 g/m², particularly preferably about 5 to 20 g/m².

The base material for the inventive food casing is a tubular casing based on cellulose hydrate or textile material. The tubular casing based on cellulose hydrate expediently has a further inner fiber reinforcement, for example made of a fibrous paper, in particular from hemp fiber paper. This casing can be produced by the viscose process. In this process the fiber reinforcement is shaped into a tube having overlapping longitudinal edges which is then coated with viscose, that is with a strongly alkaline cellulose xanthogenate solution, from the outside, from the inside, or from both sides. Subsequently, the cellulose is coagulated and regenerated in an acidic precipitation bath. The tube thereafter passes through a plurality of wash vats, if appropriate also a plasticizer vat in which, for example, there is an aqueous glycerol solution.

Instead of by the viscose process, the cellulose casing can also be produced by the more modern amine oxide process. In this process, the cellulose is not chemically derivatized, but is dissolved purely physically, in particular in N-methylmorpholine N-oxide monohydrate. This NMMO/cellulose solution can, in principle, similarly to as in the viscose process, be applied to a fibrous paper shaped to form a tube. The cellulose is then precipitated in a precipitation bath which contains a dilute aqueous NMMO solution. The cellulose gel tube is then washed with water until it is virtually free from NMMO residues. Before drying, the coloring agent can then be applied to the inside of the casing, as described.

The textile sausage skin is generally made of a flat textile material. It comprises a woven fabric, knits or nonwoven made of fibrous material, for example cotton, viscose staple fiber, polyester, polyamide, silk, or a mixture of natural and synthetic fibrous material, for example a cotton/polyester mixed fiber. The flat textile material is cut into strips of appropriate width which are then each shaped to form a tube. The longitudinal edges of the tube can be permanently bonded by sewing, gluing, sealing or other joining processes known to those skilled in the art. The textile sausage skin is, in a preferred embodiment, coated at least once on the outside, for example with a polyacrylic and/or protein, in particular with casein or collagen.

Coating or impregnating the food casing on the inside can be performed by processes which are known in principle to those skilled in the art. In a particularly simple process, the impregnation or coating is incorporated into the casing production process. In the case of the casing based on cellulose hydrate, a liquid bubble is held in a continuously newly formed loop of the casing while the casing is moved on in the machine direction (known as “slug coating”). To improve the wetting of the inside of the casing, a surface-active agent can be added to the (generally aqueous) coating liquid. In addition, it has proved to be expedient to increase the viscosity of the coating liquid by adding lecithin or similar at least partially water-soluble substances (which are not binders). By this means, a thicker film may be generated on the inside which contains correspondingly more of the coloring agent. The coating liquid can, in addition, contain conventional plasticizers such as glycerol. The impregnated or coated casing can then as customary pass through a dryer. If necessary, the casing is subsequently brought to the desired final moisture (“conditioned”), rolled up and packaged.

Alternatively, or additionally, to this type of coating or impregnation, internal mandrel spraying can proceed during shirring of the casing. This is particularly expedient when water-soluble coloring agents are used.

The inventive food casing is used especially as artificial sausage casing, in particular for scalded-emulsion sausage or raw sausage varieties, such as Fleischwurst or salami.

The examples hereinafter illustrate the invention. Percentages therein are percentages by weight, unless stated otherwise or clearly recognizable from the context.

### EXAMPLE 1

A colorless cellulose hydrate casing of caliber 49 reinforced with 19 g of hemp fiber paper was impregnated internally using a liquid bubble. The impregnation liquid consisted of

35% water-soluble barley malt extract from Alnatura

30% lecithin and

35% water.

The casing was passed through a pinch-roll pair and subsequently dried in the inflated state using hot air, then conditioned to a moisture of 12% and rolled up. The roll product was finally processed to give sections closed at one end. These sections were stuffed with scalded-emulsion sausage meat, closed with a clip and scalded with steam at about 80° C. for about 65 minutes. The sausage achieved a core temperature of about 72° C. After cooling, the casing was taken off. The sausage meat emulsion exhibited externally a significant brown rim which had a very appetizing appearance.

### EXAMPLE 2

Example 1 was repeated with the sole difference that this time an impregnation liquid of

was used.

| | |
|---|---|
| 20% | caramel powder, |
| 15% | cocoa powder (from Bensdorp) |
| 30% | lecithin and |
| 35% | water |

The sausage meat emulsion, after the casing was peeled off, exhibited on the outside a dark-brown rim which was particularly delicious.

### EXAMPLE 3

A tubular textile casing made of cotton woven fabric having a weight per unit area of 150 g/m² having a flat width of 200 mm which was provided with an acrylic coating on the outside was impregnated internally with a mixture of

| | |
|---|---|
| 35% | paprika spice sweet, crimson (from Gilde) |
| 25% | lecithin and |
| 35% | water. |

The impregnation was performed again using a liquid bubble. The casing was subsequently dried.

The textile casing was stuffed with scalded-emulsion sausage meat, sealed and scalded as described. After it was cooled, the casing was removed. The sausage exhibited a marked red rim which tasted intensely of paprika and made a very good optical impression.

1. A tubular food casing comprising textile material or regenerated cellulose impregnated or coated on the inside with at least one transferrable food additive, wherein the food additive comprises at least one foodstuff colorant and/or one coloring foodstuff, but no binder.

2. The food casing as claimed in claim 1, wherein the coloring foodstuff additionally enhances or modifies the aroma and/or flavor of a food situated in the casing.

3. The food casing as claimed in claim, wherein the coloring agent is solid and has a maximum particle size less than 0.5 mm.

4. The food casing as claimed in claim 3, wherein the solid coloring agent has a mean particle size of less than 0.3 mm.

5. The food casing as claimed in claim 1, wherein the coloring agent is liquid and/or water-soluble.

6. The food casing as claimed in claim 1, wherein the coloring agent is combined with at least one oil, and/or lecithin.

7. The food casing as claimed in claim 1, wherein the textile material or regenerated cellulose is impregnated and/or coated with 3 to 18 g/m²of the coloring agent.

8. The food casing as claimed in claim 1, wherein the casing is one based on regenerated cellulose which additionally has an internal reinforcement.

9. The food casing as claimed in claim 1, wherein the casing is based on textile material which, on the outside, additionally comprises at least one coating.

10. The food casing as claimed in claim 1, wherein the textile material comprises a woven fabric, knits or nonwoven made of fibrous material.

11. A process for producing the food casing as claimed in claims 1, wherein a bubble having an aqueous liquid which contains the coloring material in dissolved, suspended and/or dispersed form is passed through the tube and the tube is subsequently dried.

12. The process as claimed in claim 11, wherein, to the aqueous liquid, there is additionally added an oil or lecithin.

13. An artificial sausage casing comprising a food casing as claimed in claim 1.

14. The food casing as claimed in claim 4, wherein the coloring agent has a maximum particle size of less than 0.2 mm.

15. The food casing as claimed in claim 7, wherein the textile material or regenerated cellulose is impregnated with 5 to 15 g/m² of the coloring agent.

16. The food casing as claimed in claim 8, wherein the internal reinforcement is made of a fibrous paper.

17. The food casing as claimed in claim 9, wherein the coating is an acrylic or protein coating.

18. The food casing as claimed in claim 10, wherein the fibrous material is selected from cotton, viscose staple fiber, polyester, polyamide, or mixture thereof.

19. The food casing as claimed in claim 10, wherein the fibrous material is a mixture of natural and synthetic fibrous material.

20. The process as claimed in claim 12, wherein the oil or lecithin is present in a fraction of 5 to 40% by weight, based on the total weight of the liquid.

21. An artificial sausage casing as claimed in claim 13, wherein said sausage casing is for raw sausage or scalded-emulsion sausage.

22. An artificial sausage casing as claimed in claim 13, wherein said sausage casing is for salami.
